(19) United States
(12) Patent Application Publication
(10) Pub. No.: US 2026/0023827 A1
(43) Pub. Date: Jan. 22, 2026

(54) SYSTEMS AND METHODS FOR PROTECTING SENSITIVE CONTENT DURING REMOTE SPACE SHARING

(71) Applicant: JPMORGAN CHASE BANK, N.A., New York, NY (US)

(72) Inventors: Kaiming CHENG, Seattle, WA (US); Mengyu CHENG, Los Angeles, CA (US); Youngwook DO, New York, NY (US); Feiyu LU, New York, NY (US); Peijun ZHAO, Cambridge, MA (US); Ting LI, Springfield, VA (US); Shaohan HU, Yorktown Heights, NY (US); Blair MACINTYRE, Westwood, MA (US)

(21) Appl. No.: 18/774,705

(22) Filed: Jul. 16, 2024

(51) Int. Cl. G06F 21/10; G06F 21/84

(52) U.S. Cl. CPC G06F 21/106; G06F 21/84; G06F 2221/2149

(57) ABSTRACT

A method may include: a policy control computer program receiving, from a headset, an anchor identifier for an anchor in response to the headset being proximate to the anchor; (2) the policy control computer program identifying an area in which the headset is located by retrieving the area mapped to the anchor identifier in a mapping of a plurality of anchor identifiers to a plurality of areas; the policy control computer program identifying a streaming policy for the area, wherein the streaming policy restricts audio and/or video streaming from the area, allows audio and/or video streaming from the area, or restricts audio and/or video streaming from the area; the policy control computer program sending, a control signal to the headset based on the streaming policy; and the headset implementing the control signal to control streaming of audio and/or video to the policy control computer program.

### BACKGROUND OF THE INVENTION

### 1. Field of the Invention

Embodiments relate generally to systems and methods for protecting sensitive content during remote space sharing.

### 2. Description of the Related Art

Augmented Reality (AR) is becoming more of a reality. AR headsets have reshaped remote collaboration, transcending geographical boundaries. Remote users can share the same “experience” as if they were physically together. Essentially, a remote user can see exactly what a local user sees in real-time.

AR headsets often require continuous, always-on access to camera and/or other sensors access to support essential AR features. This raises a privacy and security concern, as streaming audio and video from AR headsets may include sensitive content. Existing video redaction solutions use offline processing on recorded video files, which has the potential of leaking sensitive content from the original video.

### SUMMARY OF THE INVENTION

Systems and methods for protecting sensitive content during remote space sharing are disclosed. According to one embodiment, a method may include: (1) receiving, by a policy control computer program executed by an electronic device and from a headset computer program executed by a headset, an anchor identifier for an anchor in response to the headset being proximate to the anchor; (2) identifying by the policy control computer program, an area in which headset is located by retrieving the area mapped to the anchor identifier in a mapping of a plurality of anchor identifiers to a plurality of areas; (3) identifying, by the policy control computer program, a streaming policy for the area, wherein the streaming policy restricts audio and/or video streaming from the area, allows audio and/or video streaming from the area, or prohibits audio and/or video streaming from the area; (4) sending, by the policy control computer program, a control signal to the headset computer program based on the streaming policy; and (5) implementing, by the headset computer program, the control signal to control streaming of audio and/or video to the policy control computer program.

In one embodiment, the headset computer program implements the control signal by preventing audio and/or video streaming from the headset, by redacting or obfuscating content in audio and/or video streamed from the headset, etc. The headset computer redacts or obfuscates the content based on a mesh of the area. The mesh identifies objects that may contain sensitive content, and the headset computer program redacts or obfuscates the objects.

In one embodiment, the headset computer program receives the anchor identifier by ultrawideband communication, by Bluetooth, or by Wi-Fi.

In one embodiment, the policy control computer program further receives spatial data from the headset computer program, and identifies the area based on the anchor identifier and the spatial data.

According to another embodiment, a method may include: (1) receiving, by a policy control computer program executed by an electronic device and from an anchor in one of a plurality of areas, a headset identifier for a headset from an anchor in response to the headset being proximate to the anchor; (2) identifying, by the policy control computer program, a streaming policy for the area, wherein the streaming policy restricts audio and/or video streaming from the area, allows audio and/or video streaming from the area, or prohibits audio and/or video streaming from the area; (3) sending, by the policy control computer program, a control signal to a headset computer executed by a headset associated with the headset identifier based on the streaming policy; and (4) implementing, by the headset computer program, the control signal to control streaming of audio and/or video to the policy control computer program.

In one embodiment, the headset computer program implements the control signal by preventing audio and/or video streaming from the headset, by redacting or obfuscating content in audio and/or video streamed from the headset, etc. The headset computer redacts or obfuscates the content based on a mesh of the area. The mesh identifies objects that may contain sensitive content, and the headset computer program redacts or obfuscates the objects.

In one embodiment, the anchor receives the headset identifier by ultrawideband communication, by Bluetooth, or by Wi-Fi.

In one embodiment, the policy control computer program further receives spatial data from the headset computer program, and identifies the area based on the anchor identifier and the spatial data.

According to another embodiment, a system may include: a headset executing a headset computer program; a plurality of anchors, each anchor associated with an area and transmitting an anchor identifier; an electronic device executing a policy control computer program; and a database storing a policy streaming policy for each of the plurality of areas, wherein each of the streaming policies allows, restricts, or prohibits audio and/or video streaming from a respective area. The policy control computer program may be configured to receive an anchor identifier from the headset computer program, wherein the headset is proximate to the anchor, to identify a streaming policy for the area, wherein the streaming policy restricts audio and/or video streaming from the area, allows audio and/or video streaming from the area, or prohibits audio and/or video streaming from the area, to send a control signal to the headset computer program based on the streaming policy; and the headset computer program may be configured to implement the control signal to control streaming of audio and/or video to the policy control computer program.

In one embodiment, the headset computer program may be configured to implement the control signal by preventing audio and/or video streaming from the headset.

In one embodiment, the headset computer program may be configured to implement the control signal by redacting or obfuscating content in audio and/or video streamed from the headset.

In one embodiment, the headset computer may be configured to redact or obfuscate the content based on a mesh of the area.

In one embodiment, the mesh identifies objects that may contain sensitive content, and the headset computer program redacts or obfuscates the objects.

In one embodiment, the policy control computer program may be configured to receive spatial data from the headset computer program, and to identify the area based on the anchor.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for protecting sensitive content during remote space sharing according to an embodiment;

FIG. 2 depicts a method for protecting sensitive content during remote space sharing according to an embodiment.

### DETAILED DESCRIPTION OF PREFERRED EMBODIMENTS

Embodiments relate generally to systems and methods for protecting sensitive content during remote space sharing.

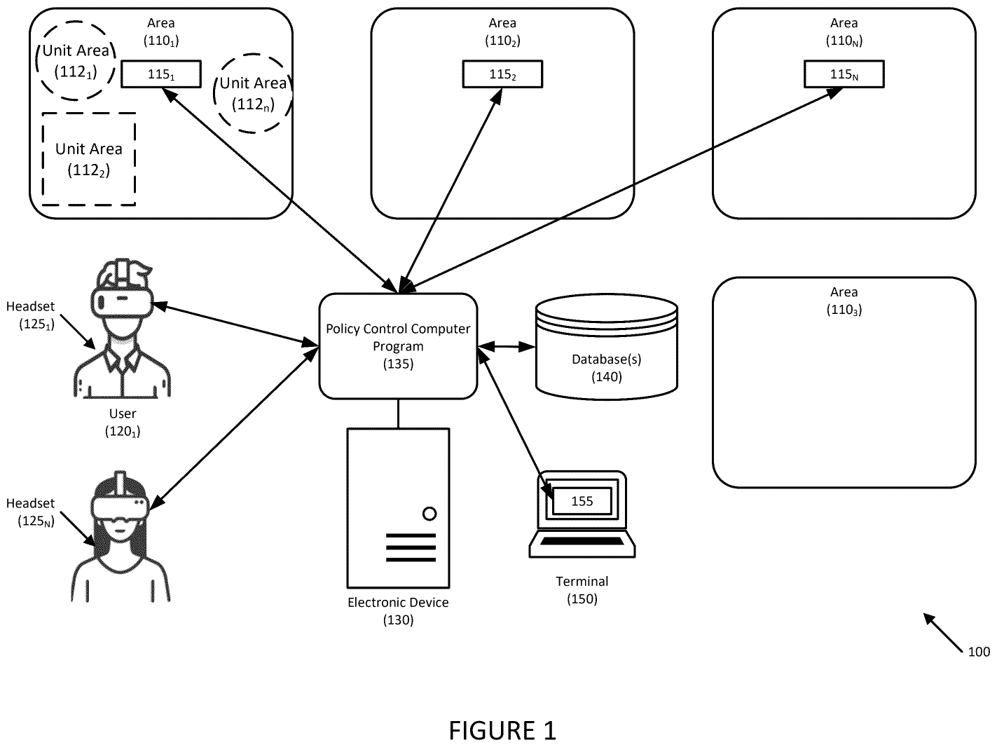

Referring to FIG. 1, a system for protecting sensitive content during remote space sharing is disclosed according to an embodiment. System 100 may include a plurality of areas 110 (e.g., area 110₁, area 110₂, area 110₃, . . . area 110_{N}). Areas 110 may include conference rooms, offices, common areas, etc. Each area 110 may include anchor 115 (e.g., anchor 115₁, anchor 115₂, . . . anchor 115_{N}). Not all areas 110 include an anchor; for example, in FIG. 1, area 110₃ does not include an anchor.

Each anchor 115 may be associated with an anchor identifier. An anchor identifier may uniquely identify the anchor to computer program 135. Any suitable identifier may be used as an anchor identifier.

In one embodiment, area 110 may be partitioned into a plurality of non-overlapping unit areas (e.g., unit area 112₁, unit area 112₂, . . . unit area 112ₙ). For example, one non-overlapping unit area 112 may include a whiteboard; another non-overlapping area 112 may include a desk or table. Another may include a window. The plurality of non-overlapping areas may be treated as separate areas, or may later be treated as a single area.

In one embodiment, area 110 may include objects, such as whiteboards, desks, tables, screens, documents, etc.

Anchors 115 may include, for example, ultrawide band (UWB) devices, Bluetooth devices, Bluetooth Low Energy (BLE) devices, Wi-Fi devices, 5G devices, etc. Anchors 115 may transmit a unique identifier, such as an anchor identifier, that may be associated with and mapped to their respective areas 110. Anchors 115 may further provide a reference to 3D spatial data for their respective areas.

The association may be stored, for example, in database 140.

In one embodiment, anchors 115 may be static in that they broadcast the unique identifier that may be received by headsets 125 when headsets are proximate to, or within a certain range of, anchors 115. For example, the transmission range of anchors 115 may be configured based on the size of their respective areas 110.

Each headset 125 may have a headset identifier that may uniquely identify the headset to policy control computer program 135.

In another embodiment, anchors 115 may broadcast a location (e.g., a GPS location) or location identifier (e.g., a conference room number, office number, etc.).

In another embodiment, anchors 115 may communicate with computer program 135, such as a policy control computer program. For example, anchors may communicate an identification of any headset 125 that may be identified within their respective areas. Anchors 115 may further communicate additional information, such as a radio signal strength between anchor 115 and headset 125, distance between anchor 115 and headset 125, a position of headset 125 within area 110, an orientation of headset 125 within area 110, etc.

Computer program 135 may be executed by electronic device 130, such as a server (e.g., physical and/or cloud-based), computers (e.g., workstations, desktops, laptops, notebooks, tablets, etc.), Internet of Things (IoT) appliances, etc. Computer program 135 may maintain a mapping of areas 110 to anchors 115 in, for example, database 140.

Database 140 may store the mappings, and may also store streaming policies for each area 110, for each user 120, etc.

Terminal 150, which may be a computer or any suitable electronic device, may execute terminal computer program 155. A user, such as an administrator, may set streaming policies for areas 110 via terminal computer program 155.

Headsets 125 (e.g., headset 125₁, headset 125_{N}) may be worn by users 120 (e.g., user 120₁, user 120_{N}). Headsets 125 may be associated with a specific user 120, or may be unassigned.

Headsets 125 may include one or more cameras (not shown) that capture what user 120 is seeing, one or more microphones (not shown) that capture what user 120 is hearing, one or more displays (not shown) to display video content to user 120, one or more speakers (not shown) to output audio to user 120, one or more transceiver (e.g., UWB, BLE, Wi-Fi, etc.) to identify and/or communicate with anchors 115, and one or more sensors (not shown) to understand, localize and/or reconstruct area 110 in mesh. For example, headsets 125 may include spatial sensors (e.g., radar, sonar, LiDAR, etc.).

Headsets 125 may execute a headset computer program (not shown) that controls the streaming of audio and video, as well as the communication of any other data (e.g., data used to create a mesh of area 110) to computer program 135.

Headsets 125 may further communicate user data (e.g., personal identifiable information such as facial images, voice, etc.; movement data such as eye tracking and hand tracking; input from the user such as selected content, etc.), bystander data for others in area 110, such as personal identifiable information, movement data, etc., environment data (e.g., for area 110) including a location, a semantic meaning (e.g., conference room, bedroom, etc.), an environment layout, objects (e.g., notebooks, whiteboards, photos), information on objects (e.g., writing, images), etc.

Headsets 125 may also communicate information on their location to computer program 135, such as a unique identifier received from anchor 115, a radio signal strength with anchor 115, a distance between it and anchor 115, a position of headset 125 within area 110, an orientation of headset 125 within area 110, etc. Headsets 125 may further communicate GPS data.

In one embodiment, headsets 125 may, by default, be prohibited from streaming content. Headsets 125 may stream content in response to receiving a control signal from computer program 135.

Computer program 135 may receive location data from anchor 115 and/or headset 125 and may apply a streaming policy to allow or deny streaming of content from area 110 associated with the location. For example, computer program 135 may receive an identifier of anchor 115 from headset 125, or an identification of headset 125 from anchor 115, and may determine area 110 in which headset 125 is located. Alternatively, computer program 135 may receive a GPS location for headset 125, and may determine area 110 in which headset 125 is located. If an area for headset 125 cannot be located (e.g., the area does not have an anchor, the anchor is not registered or associated with an area, etc.), streaming may be rejected.

In one embodiment, the streaming policy may allow streaming of audio and/or video data from headset 125, may prohibit the streaming of audio and/or video data from headset 125, or may enable audio streaming but not video streaming, may enable video streaming but not audio streaming, may enable streaming with a delay (e.g., to allow for “dumping” streaming content before it is transmitted from headset 125, may enable streaming at a degraded quality, etc. In one embodiment, the streaming policy may be set by a policy administrator.

In one embodiment, the streaming policy may be a role-based system and multiple priority streaming policies may be configured to reflect different access control capabilities. For example, a policy administrator for an organization may define a top priority streaming policy, such as no video sharing on floor X. A developer may define a mid-priority streaming policy, such as granting video sharing in room Y, floor Z, for some user group. If two streaming policies conflict with each other, the conflict may be resolved in favor of the higher priority policy.

Thus, the streaming policies ensure that only authorized user have access to sensitive or restricted streams, thereby enhancing security and compliance with regulatory requirements. The roles and policies may be defined and managed through a centralized administration panel, allowing for easy updates and modifications as needed.

Computer program 135 may also receive Wi-Fi data, 3D spatial data (e.g., point cloud), etc. to facilitate localization of headset 125. A “point cloud” refers to a collection of data points within a three-dimensional coordinate system. Each point represents a single spatial measurement on the surface of an object. Collectively, a point cloud depicts the entire external surface of an object or an entire space.

In one embodiment, computer program 135 may apply entitlements for user 120 (e.g., to send or receive streaming content) may also be applied before streaming is allowed or denied.

After the streaming policy and/or entitlements are applied, computer program 135 may communicate a control signal to headset 125 that may enable or disable streaming, may enable audio streaming but not video streaming, may enable video streaming but not audio streaming, may enable streaming with a delay (e.g., to allow for “dumping” streaming content before it is transmitted from headset 125, may enable streaming at a degraded quality, etc. The headset computer program may then take an appropriate action in response to the control signal.

In one embodiment, computer program 135 may apply policies to the entire area 110, individual non-overlapping unit areas 112 of area 110, a plurality of individual non-overlapping unit areas 112 of area 110, etc.

In one embodiment, computer program 135, or a separate computer program (not shown) may receive the streaming content and may apply filters to the streaming content. For example, filters may filter content in the video stream and/or the audio stream, environment data, user data, bystander data, according to the streaming policy and/or entitlements. For example, visual data may be obfuscated, replaced with an alternate visual, etc. Personal identifiable information may be deidentified.

An example of content filtering is disclosed in U.S. patent application Ser. No. 17/504,275, filed Oct. 18, 2021, the disclosure of which is hereby incorporated, by reference, in its entirety.

Once filtered, the streaming data may be output to a second user (e.g., user 120_{N} using headset 125_{N}), to terminal computer program 155, may be stored, etc.

In one embodiment, computer program 135 may create a detailed representation of real-world surfaces (i.e., a mesh) of area 110. The mesh may be presented as a static 3D model that provides abstracted proxy for objects in area 110 without leaking identifiable information. For example, a table in area 110 may be presented as a 3D primitive shape (such as cube) to indicate the approximate height, width, and length of the real-world object.

The mesh of area 110 may be used to partition area 110 into a plurality of non-overlapping unit areas 112. For example, if area 110 is an office, the mesh may be used to identify and partition a desk mesh into a desk unit area, a whiteboard mesh into a whiteboard unit area, etc. Computer program 135 may apply policies to the individual unit areas 112 separately.

In one embodiment, the mesh may be used to identify objects that may include sensitive data, such as a whiteboard, a desk, etc.

In one embodiment, the mesh may be used to localize the user within area 110 by matching with the output from the spatial sensor(s). Computer program 135 may then localize the user in the global position, in relation to the regional localization.

The mesh of area 110 and or unit areas 112 may be used to place immersive and effective alternate visual or obfuscation based on the geometry information from the mesh. For example, the geometry of the alternative visual may depend on the geometry of the object that may include sensitive content, e.g., a flat screen versus a curved screen. By shaping the alternative visual or obfuscation to fit the mesh may enhance privacy protection.

The mesh may also be used to provide classification of the objects in area 110. For example, if there is a policy to be applied to all whiteboards, computer program 135 may retrieve the classification result from the existing meshes and automate the policy assignment.

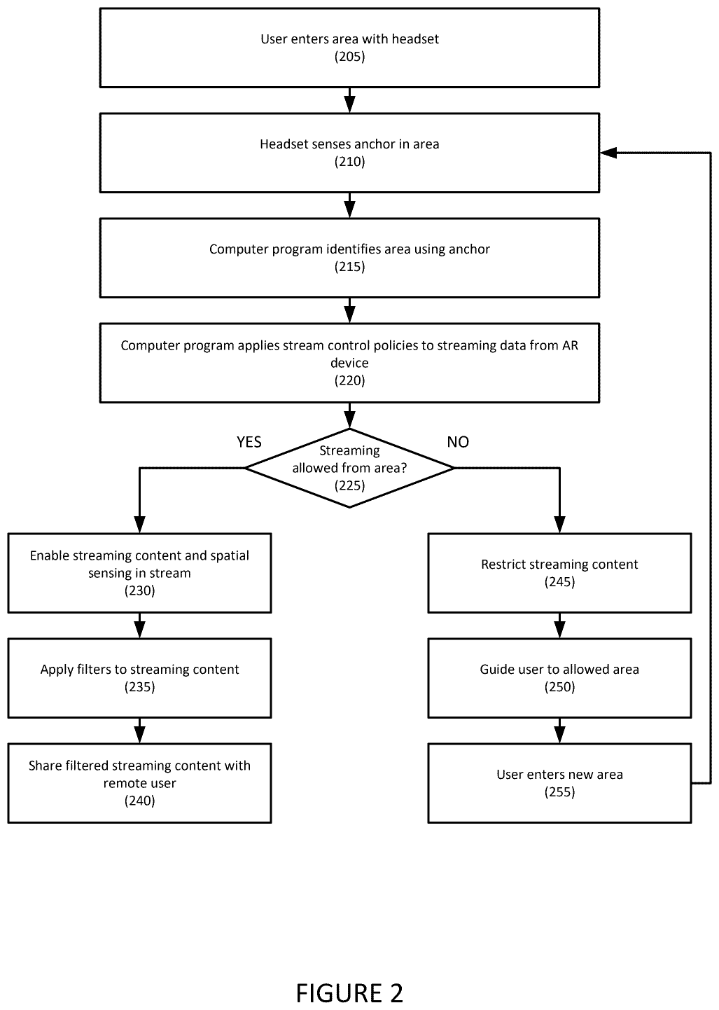

Referring to FIG. 2, a method for automatic redaction of sensitive content from video streams is disclosed according to an embodiment.

In step 205, a user may enter an area with a headset, such as a headset.

In step 210, the headset may sense an anchor in the area. For example, the anchor may be a UWB device, a Bluetooth device, a BLE device, a Wi-Fi device, a 5G device, etc. that may transmit an identifier, such as an anchor identifier, that may be associated with the area, a reference to 3D spatial data for the area, etc.

In another embodiment, the anchor may identify the headset, and may receive an identifier for the headset device. The identifier may be used to identify the headset.

In step 215, a computer program, such as a policy control computer program, may identify the area using the anchor identifier. For example, the computer program may retrieve a mapping of anchors to areas and may use that to identify the area.

In another embodiment, the computer program may use a GPS location and feature matching from the real-world object and a spatial data received from the headset to identify the area by comparing the spatial data received to a database of meshes for different areas.

In one embodiment, the area may be partitioned into a plurality of non-overlapping unit areas, and the unit area in which the headset is located may be identified. In another embodiment, the unit area that the user is looking at (i.e., streaming video of, such as a whiteboard, a desk, etc.) may be identified, as it is possible that the headset may be physically located in one unit area, but streaming video of a different unit area.

In step 220, the computer program may apply one or more stream control policies for streaming data from the headset. For example, the stream control policy may allow or prohibit streaming from certain areas or unit areas, may place restrictions on any streaming, etc.

In another embodiment, the control policy may allow streaming within an area, but may prohibit or restrict streaming of data from a unit area. For example, streaming may be allowed in a conference room, but streaming video of a whiteboard in the conference room, which may be a unit area, may be prohibited or restricted.

In one embodiment, the computer program may check the user's entitlements to determine if the user is authorized to stream from the area or unit area, or of objects within a unit area.

In step 225, if streaming is allowed from the area, in step 230, the computer program may send a control signal to the headset that enables the headset to stream data. For example, the headset may stream user data (e.g., audio and video), environment data, and bystander data to the computer program.

In one embodiment, based on the streaming policy, the control signal may instruct the headset to stream the data in a degraded form, with a delay, etc.

In step 235, the computer program may receive the streaming data from the headset and may apply one or more filters to the streaming data. The filters that may be applied may be associated with the streaming policy. For example, the computer program may redact or obfuscate the user data, the environment data, and/or the bystander data, may deidentify any personal identifiable information in the streaming data, etc.

In one embodiment, a mesh of the area, or of the unit area, may be used to identify potential sources of data leaks, such as whiteboards, monitors, desks/tables, etc. The computer program may use the mesh to identify such sources, and may automatically redact or obfuscate the area of the mesh.

In step 240, the computer program may share the filtered streaming content with a remote user, an external application (e.g., an AI application with the ability to reason about the vision or spatial information), etc. In one embodiment, before sharing the filtered streaming data, the computer program may verify that the remote user is entitled to receive the filtered streaming data.

If the computer program determines that streaming is not allowed from the area, or the area is not associated with an anchor, in step 245, the computer program may send a control signal to the headset to disable or restrict streaming from the headset. The headset may respond by not streaming data.

In step 250, the computer program may optionally guide the user to an area in which streaming is allowed. For example, the computer program may identify an area from which streaming is authorized, and may direct the user to that location. In one embodiment, the computer program may also check whether the area is available (e.g., no meetings are scheduled, it is not an occupied office, etc.) before providing directions to the area.

In step 255, the user may enter the new area, and the process may return to step 210.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, cloud services, etc. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a policy control computer program executed by an electronic device and from a headset computer program executed by a headset, an anchor identifier for an anchor in response to the headset being proximate to the anchor;
identifying by the policy control computer program, an area in which headset is located by retrieving the area mapped to the anchor identifier in a mapping of a plurality of anchor identifiers to a plurality of areas;
identifying, by the policy control computer program, a streaming policy for the area, wherein the streaming policy restricts audio and/or video streaming from the area, allows audio and/or video streaming from the area, or prohibits audio and/or video streaming from the area;
sending, by the policy control computer program, a control signal to the headset computer program based on the streaming policy; and
implementing, by the headset computer program, the control signal to control streaming of audio and/or video to the policy control computer program.

2. The method of claim 1, wherein the headset computer program implements the control signal by preventing audio and/or video streaming from the headset.

3. The method of claim 1, wherein the headset computer program implements the control signal by redacting or obfuscating content in audio and/or video streamed from the headset.

4. The method of claim 3, wherein the headset computer redacts or obfuscates the content based on a mesh of the area.

5. The method of claim 4, wherein the mesh identifies objects that may contain sensitive content, and the headset computer program redacts or obfuscates the objects.

6. The method of claim 1, wherein the headset computer program receives the anchor identifier by ultrawideband communication, by Bluetooth, or by Wi-Fi.

7. The method of claim 1, wherein the policy control computer program further receives spatial data from the headset computer program, and identifies the area based on the anchor identifier and the spatial data.

8. A method, comprising:
receiving, by a policy control computer program executed by an electronic device and from an anchor in one of a plurality of areas, a headset identifier for a headset from an anchor in response to the headset being proximate to the anchor;
identifying, by the policy control computer program, a streaming policy for the area, wherein the streaming policy restricts audio and/or video streaming from the area, allows audio and/or video streaming from the area, or prohibits audio and/or video streaming from the area;
sending, by the policy control computer program, a control signal to a headset computer executed by a headset associated with the headset identifier based on the streaming policy; and
implementing, by the headset computer program, the control signal to control streaming of audio and/or video to the policy control computer program.

9. The method of claim 8, wherein the headset computer program implements the control signal by preventing audio and/or video streaming from the headset.

10. The method of claim 8, wherein the headset computer program implements the control signal by redacting or obfuscating content in audio and/or video streamed from the headset.

11. The method of claim 10, wherein the headset computer redacts or obfuscates the content based on a mesh of the area.

12. The method of claim 11, wherein the mesh identifies objects that may contain sensitive content, and the headset computer program redacts or obfuscates the objects.

13. The method of claim 8, wherein the anchor receives the headset identifier by ultrawideband communication, by Bluetooth, or by Wi-Fi.

14. The method of claim 8, wherein the policy control computer program further receives spatial data from the headset computer program, and identifies the area based on the anchor identifier and the spatial data.

15. A system, comprising:
a headset executing a headset computer program;
a plurality of anchors, each anchor associated with an area and transmitting an anchor identifier;
an electronic device executing a policy control computer program; and
a database storing a policy streaming policy for each of the plurality of areas, wherein each of the streaming policies allows, restricts, or prohibits audio and/or video streaming from a respective area;
wherein the policy control computer program is configured to receive an anchor identifier from the headset computer program, wherein the headset is proximate to the anchor, to identify a streaming policy for the area, wherein the streaming policy restricts audio and/or video streaming from the area, allows audio and/or video streaming from the area, or prohibits audio and/or video streaming from the area, to send a control signal to the headset computer program based on the streaming policy; and
the headset computer program is configured to implement the control signal to control streaming of audio and/or video to the policy control computer program.

16. The system of claim 15, wherein the headset computer program is configured to implement the control signal by preventing audio and/or video streaming from the headset.

17. The system of claim 15, wherein the headset computer program is configured to implement the control signal by redacting or obfuscating content in audio and/or video streamed from the headset.

18. The system of claim 17, wherein the headset computer is configured to redact or obfuscate the content based on a mesh of the area.

19. The system of claim 18, wherein the mesh identifies objects that may contain sensitive content, and the headset computer program redacts or obfuscates the objects.

20. The system of claim 15, wherein the policy control computer program is configured to receive spatial data from the headset computer program, and to identify the area based on the anchor.
